(19) United States
(12) Patent Application Publication
(10) Pub. No.: US 2005/0055366 A1
(43) Pub. Date: Mar. 10, 2005

(54) Document collection apparatus, document retrieval apparatus and document collection/retrieval system

(75) Inventors: Masachika Fuchigami, Kanagawa (JP); Yoshitaka Hamaguchi, Nara (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/887,101

(22) Filed: Jul. 9, 2004

(30) Foreign Application Priority Data
Sep. 8, 2003 (JP) 2003-315703

(51) Int. Cl. G06F 17/00

(52) U.S. Cl. 707/102

(57) ABSTRACT

The document collection/retrieval system includes a document database which preserves the same document information indicating whether the same document data having same document contents exist or not; a document collection apparatus which is provided with a document information update section, which updating the same document information based on the judgment result of a document contents judgment section; and a documents retrieval apparatus which is provided with an same document deletion section which, at the time of document retrieval, leaves only one same document data from among same document data, and deletes other remaining same document data based on the same document information of the each document data retrieved by the document retrieval section and a retrieval document information update section which updates the same document information based on the judgment result of the retrieval document contents judgment section with regard to each of remaining document data.

### CROSS REFERENCE TO RELATED APPLICATIONS

The disclosure of Japanese Patent Application No. JP 2003-315703 filed on Sep. 8, 2003 including the specification, drawings and abstract is incorporated herein by reference in its entirety.

### TECHNICAL FIELD

The present invention relates to a document collection apparatus, a document retrieval apparatus and a document collection/retrieval system and, for example, to a document collection apparatus capable of extracting and preserving document data in a document database, a document retrieval apparatus capable of retrieving document data satisfying a retrieval condition as inputted, and a document collection/retrieval system which includes the above document collection apparatus and document retrieval apparatus as constituents thereof and is able to retrieve and output the document data satisfying the given retrieval condition.

### BACKGROUND OF THE INVENTION

Heretofore, when a user retrieves his necessary document from a document preservation device (e.g. a document database, a memory device, etc.) preserving a lot of documents, there have been provided some document retrieval systems enabling him to retrieve a document including his inputted keyword from the document preservation device.

However, in case of the Internet, since addresses in the network are individually assigned to the documents so as to be different from one another, it happens that a plurality of same documents having same contents but a different address are preserved in the document preservation device. Thus, it also happens that the document retrieval system repetitively outputs same documents as a retrieval result. Speaking from the user's standpoint, this causes not only that he has to unnecessarily spend a long time for the document retrieval but also that he might fail in obtaining his really needful document. Besides, viewing from the standpoint of the document retrieval system, there is caused such a problem that the processing load relating to the document retrieval is increased.

As a technique solving such problems, there has been proposed a technique disclosed by the Japanese Patent Laid-open Publication No. 2002-140366. According to this technique, the document contents identity of the objective documents is judged and if they are judged to be same or approximately same, they are deleted.

The above patent document describes a document retrieval apparatus wherein at the time of executing the document retrieval, a relevant word related to an inputted keyword is first elected from among words appearing in a retrieval target document and then, the document retrieval is carried out based on the keyword and the relevant word as elected.

To put it more in detail, the above patent document describes the following technique. That is, the document retrieval apparatus is provided with a document database (document preservation device) which has a document list indicating the document contents showing the number of words included in each document, the appearance frequency of each word, and so forth. When electing the relevant word related to the keyword, it is judged whether a same document or an approximately same document exists or not based on the document contents. All the documents as judged to be same or approximately same are deleted and the relevant word is elected from among remaining documents that are not deleted.

According to the technique disclosed by the above patent document, however, since the document contents identity judgment has to be executed at every time of executing the keyword input and electing the relevant word (new keyword) related to the keyword, the processing load relating to execution of the document contents identity judgment comes to increase because of the following reason.

Because the document contents identity judgment is executed not only at the time of the keyboard input but also at the time after electing the relevant word without taking account of the previous document contents identity judgment result, and in addition, the document contents identity judgment is carried out at the time of electing the relevant word related to the elected relevant word (new keyword).

The above-mentioned technique is nothing but a technique related to the relevant word election, according to which all the documents judged same are deleted. In the document retrieval system, however, it is desirous that only one document is outputted from among same documents having overlapping contents.

For example, when the document retrieval is executed by making use of the Internet and the document preservation device preserves the Web page as a document, the name (network address) assigned to the Web page becomes plural in spite of a same document. It happens that the document preservation device preserves quietly same document copies. In the case like this, it is desirous to leave any one of the same documents (identical pages) and not to use other same document (identical page).

Furthermore, it is desirous for the document preservation apparatus to outputs to be able to output the newest document with the latest contents at the time of document retrieval. However, it happens that the document contents after being preserved is sometimes dynamically altered entirely or revised partly or deleted in part. Accordingly, there is such a problem that it is difficult to statically execute the document contents identity judgment

### SUMMARY OF THE INVENTION

Accordingly, the invention has been made in view of the problems as described above and an object of it is to provide a document collection apparatus, a document retrieval apparatus and a document collection/retrieval system, by which the document retrieval processing load due to existence of the same document is reduced, and the result of document identity judgment on the document of which the contents is altered at the time of executing the document retrieval and the document collection can be reflected at the next time of executing the document retrieval and the document collection.

In order to solve the above problems, according to an aspect of the invention, there is provided a document collection apparatus preserving document data collected from a outside apparatus in a document database which preserves same document information indicating whether or not same document data having same document contents exist, such that the same document information is related to each document data. This document collection apparatus is provided with: (1) a preservation document affirmation section, which affirms whether or not document data corresponding to collection target document data is preserved in the document database; (2) a same document existence affirmation section, which affirms whether or not same document data of the document data corresponding to the document collection target document data exists in the document database based on the same document information of the document data corresponding to the collection target document data, when the document data corresponding to the collection target document data is preserved in the document database; (3) a document extraction section, which extracts the collection target document data and the same document data of the document data corresponding to the collection target document data from the outside apparatus, when the same document data of the document data corresponding to the collection target document data exists in the document database; (4) a document contents judgment section, which judges whether or not document contents of the extracted collection target document data and document contents of the extracted same document data of the document data corresponding to the collection target documents data are same; and (5) a document information update section, which updates the same document information relating to the extracted collection target document data and the extracted same document data of the document data corresponding to the collection target document based on the judgment result of the document contents judgment section.

Furthermore, in order to solve the above problems, according to another aspect of the invention, there is provided a document retrieval apparatus retrieving the document data satisfying a retrieval condition as inputted, from a document database which preserves same document information indicating whether or not same document data having same document contents exist, such that the same document information is related to each document data. This document retrieval apparatus is provided with: (1) a document retrieval section, which retrieves the document data satisfying the retrieval condition from the document database; (2) an same document deletion section, which judges whether or not the same document data exist among the document data retrieved by the document retrieval section, based on the same document information of the document data retrieved by the document retrieval section, and leaves only one same document data and deletes other same document data among the same document data if the same document data exists; (3) a retrieval document contents judgment section, which judges whether document contents of the document data except the same document data deleted by the same document deletion section among the document data retrieved by the document retrieval section are same or not; (4) a retrieval document information update section, which updates the same document information related to the document data based on the judgment result by the retrieval document contents judgment section; and (5) a retrieval result output section, which outputs the document election result based on the judgment result by the retrieval document contents judgment section.

Still further, in order to solve the above problems, according to still another aspect of the invention, there is provided a document retrieval apparatus which retrieves r the document data satisfying a retrieval condition as inputted, from a document database which preserves same document information indicating whether or not same document data having same document contents exist, and weight information related to the same document data, such that the same document information and the weight information are related to each document data. This document retrieval apparatus is provided with: (1) a document retrieval section, which retrieves the documents data satisfying the retrieval condition from the document database; (2) a retrieval document contents judgment section, which judges whether document contents of the document data retrieved by the document retrieval section are same or not; (3) a retrieval document information update section, which updates the same document information and the weight information related to the document data based on the judgment result by the retrieval document contents judgment section ; and (4) a retrieval result output section, which outputs the document data retrieved by the document retrieval section., along with the weight information of the document data retrieved by the document retrieval section.

Still further, in order to solve the above problems, according to still another aspect of the invention, there is provided a document collection/retrieval system which is provided with (1) a document database which preserves same document information indicating whether or not same document data having the same document contents exist, such that the same document information is related to each document data, (2) a document collection apparatus as described above, and (3) a document retrieval apparatus as described above.

### BRIEF DESCRIPTION OF THE DRAWINGS

FIG. 1 is a block diagram showing the entire constitution of a document collection/retrieval system according to the first embodiment of the invention.

FIG. 2 is a table showing an example list of collection targets held by a collection waiting list according to the first embodiment of the invention.

FIG. 3 is a table showing an example list of collected documents held by a collection completion list according to the first embodiment of the invention.

FIG. 4 is a table showing an example of preserved contents of the document database 1 according to the first embodiment of the invention.

FIG. 5 is a flowchart showing a document collecting operation executed on the step by step basis according to the first embodiment of the invention.

FIGS. 6A through 6D are tables for explaining the progress of the data management executed by respective constituents related with the document collecting operation according to the first embodiment of the invention.

FIG. 7 is a flowchart showing a document retrieval operation executed on the step by step basis according to the first embodiment of the invention.

FIGS. 8A through 8C are tables showing an example of the retrieval result obtained by a DB retrieval portion according to the first embodiment of the invention.

FIG. 9 is a block diagram showing the entire constitution of a document collection/retrieval system according to the second embodiment of the invention.

FIG. 10 is a table showing an example of preservation contents of the document database according to the second embodiment of the invention.

FIG. 11 is a flowchart showing a document collecting operation executed on the step by step basis according to the second embodiment of the invention.

FIG. 12 is a table showing an example of preserved contents of the document database updated by the document collecting operation according to the second embodiment of the invention.

FIG. 13 is a flowchart showing a document retrieval operation executed on the step by step basis according to the second embodiment of the invention.

FIG. 14 is a table showing an example of the retrieval result obtained by a DB retrieval portion according to the second embodiment of the invention.

FIG. 15 is a table showing an example of preserved contents of the document database updated by the document retrieval operation according to the second embodiment of the invention.

### DETAILED DESCRIPTION OF THE PREFERRED EMBODIMENTS

In the following, preferred embodiments of a document collection apparatus, a document retrieval apparatus and a document collection/retrieval system according to the invention will now be described in detail with reference to the accompanying drawings. Besides, through this specification and the drawings, constituents of the invention having substantially identical functions and structural features are denoted with identical reference numerals or marks, thereby omitting repetitive and redundant descriptions thereabout.

### (A) First Embodiment

In the following, the first embodiment relating to a document collection apparatus, a document retrieval apparatus and a document collection/retrieval system according to the invention will be explained with reference to the drawings.

The first embodiment will be explained about the application of the invention to the case where the document data is retrieved on the basis of a retrieval conditions as inputted by using the Internet, for example. In this embodiment, it is assumed that the document data includes a document file and a document written in the form of data such as a HTML document data, (referred to as “document” hereinafter).

### (A-1) Constitution of the First Embodiment

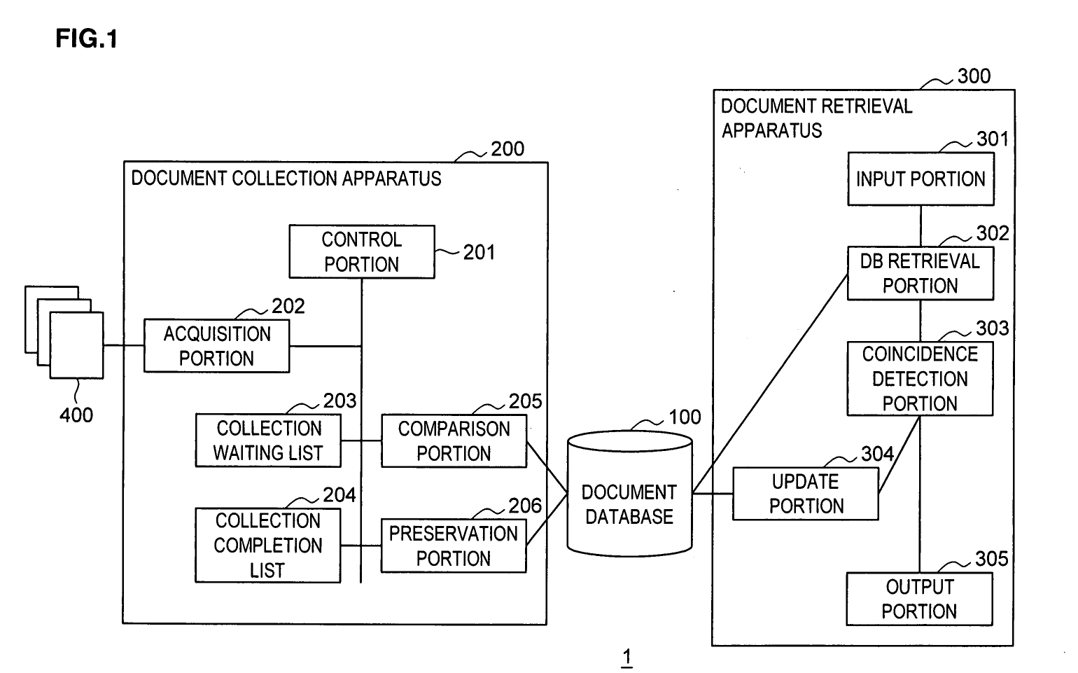

FIG. 1 is a block diagram functionally showing an entire structure of the document collection/retrieval system according to the first embodiment

As shown in FIG. 1, the document collection/retrieval system can be divided roughly into a document database 100 capable of preserving a plurality of documents, a document collection apparatus 200 which extracts a collection target document (e.g. HTML document) 400 and registers it in the document database 100, and a document retrieval apparatus 300 which retrieves and outputs a document satisfying the retrieval condition as inputted from the document database 100.

The document collection apparatus 200 is an apparatus having at least communication facility. This document collection apparatus 200 is constituted with the following things, for example, a computer of which the control portion includes an embedded program, a program executed by the control portion of a computer, a storage media storing a program executed by the control portion of a computer, a device for taking in the information obtained, for example, through the communication with the terminal of a computer or a program executed by the control portion.

In the first embodiment, the document collection apparatus 200 includes a control portion 201, an extraction portion 202 controlled by the control portion 201, a collection waiting list 203, a collection completion list 204, a comparison portion 205, and a preservation portion 206. Besides, a preservation document affirmation section is constituted by the control portion 201 and the comparison portion 205, for example. A document collection section is constituted by the control portion 201 and the extraction portion 202, for example. A document contents judgment section is constituted by the control portion 201 and the comparison portion 205, for example. A document information update section is constituted by the control portion 201 and the preservation portion 206, for example. A representative document election section is constituted by the control portion 201 and the comparison portion 205, for example.

Besides, the document retrieval apparatus 300 is constituted with the following things, for example, a computer of which the control portion includes an embedded program, a program executed by the control portion of a computer, a storage media storing a program executed by the control portion of a computer, a device for taking in the information obtained, for example, through the communication with the terminal of a computer, or a program executed by the control portion.

In the first embodiment, the document retrieval apparatus 300 includes an input portion 301, a document database retrieval portion 302 (referred to as “DB retrieval portion” in FIG. 1 and hereinafter), a coincidence detection portion 303, an update portion 304, and an output portion 305. Besides, a document retrieval section is constituted by the DB retrieval portion 302, for example. A same document deletion section is constituted by the coincidence detection portion 303, for example. A retrieved document contents judgment section is constituted by the coincidence detection portion 303, for example. A retrieved document information update section is constituted by the update portion 304, for example. A retrieval result output section is constituted by the output portion 305, for example. A representative document election section is constituted by the coincidence detection portion 303, for example.

The internal structure of the document collection apparatus 200 will be first explained in the following.

The control portion 201 controls operational functions of the document collection apparatus 200.

The control portion 201 manages the collection waiting list 203 which is a list of documents to be collected (referred to as “collection target document” hereinafter). At the time of executing document collection, the control portion 201 writes the document site (e.g. URL and others) of the collection target document to the collection waiting list 203. When starting the document collection, the control portion 201 writes one or more document sites designated in advance as a start point to the collection waiting list 203.

Besides, the control portion 201 also manages the collection completion list 204 which is a list of documents already collected (referred to as “collection completion document” hereinafter). The control portion 201 writes the document site of the collection target document which is already extracted through the extraction portion 202 to the collection completion list 204.

The control portion 201 collates the document site of the collection target document with those of the documents listed in the collection completion list 204 and judges if the above collection target document has been already collected or not. Furthermore, the control portion 201 retrieves the document database 100 to determine whether or not the document database 100 includes a documents which have same document contents as the document corresponding to the collection target document, and then, in response to this retrieval result, the control portion 201 gives the document site of the above collection target document to the extraction portion 202 to let this extraction portion extract the above collection target document Furthermore, the control portion 201 gives the document site of the collection target document to the comparison portion 205 to let this comparison portion judge whether or not the document database 100 includes the document site of the document corresponding to the collection target document If the document database 100 includes the document site of the document corresponding to the collection target document, the control portion 201 lets the comparison portion 205 judge whether or not the document database 100 includes a same document based on the same document information of that document. Still further, the control portion 201 gives the comparison portion 205 the document extracted by the extraction portion 202 to let the comparison portion 205 judged whether or not this extracted document has same document contents as each document of the document database 100 (judgment on document contents identity).

Still further, the control portion 201 gives the extracted document to the preservation portion 206 to preserve them in the document database 100. The control portion 201 gives the same document information to the preservation portion 206 to preserve them in the document database 100. This same document information is made and related to each corresponding document based on the result of the document contents identity judgment executed thereon by the comparison portion 205.

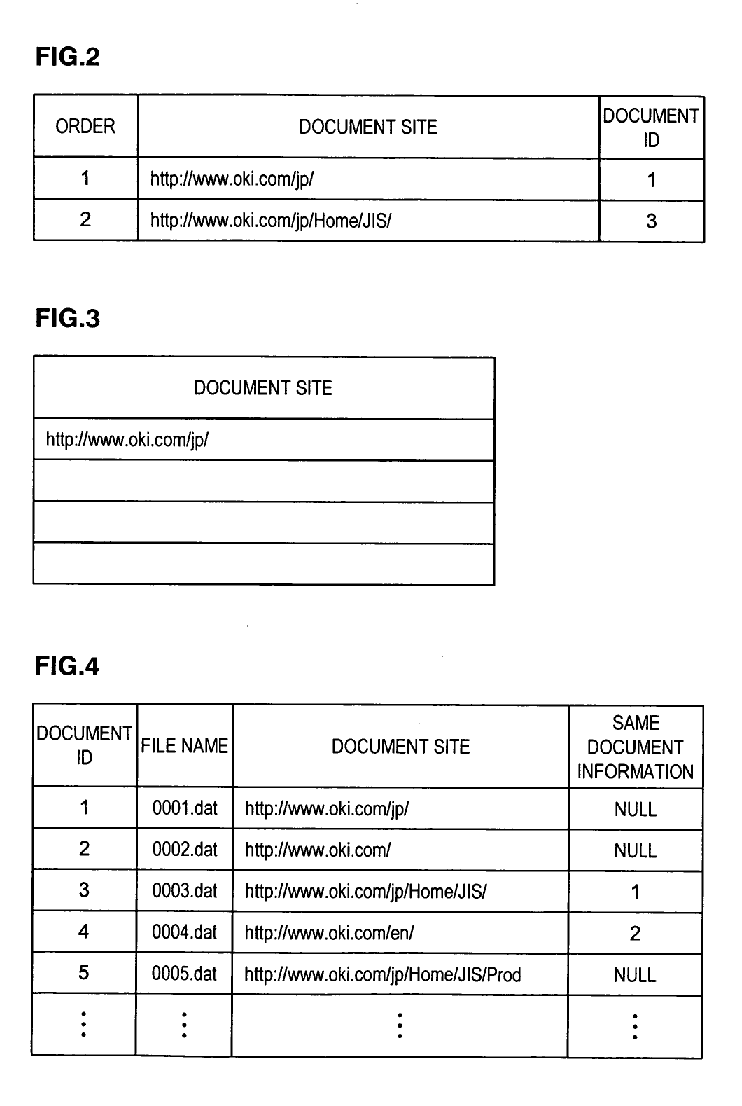

The collection waiting list 203 is a list holding the collection target documents given from the control portion 201. FIG. 2 shows an example of the collection waiting list 203. As will be seen from FIG. 2, the collection waiting list 203 shows the following items, which are the collection order of collection target documents, the document site of each collection target document, and the document ID for managing the document by the document collection/retrieval system 1, to each of which has relevance to respective documents.

For example, FIG. 2 indicates that the collection target document with the order number [1] exists at URL of [http://www.oki.com/jp/] and the document ID for managing this collection target document is [1].

When the extraction portion 202 extracts the collection target document, the contents of the collection target document list are changed by the control of the control portion 201. In other words, after the extraction portion 202 extracts a document, the document site and document ID related to the extracted document are deleted from the collection waiting list 203.

The collection completion list 204 is a list for holding the list of collection completion documents given from the control portion 201. FIG. 3 shows an example of the collection completion list 204. When completing the preservation/updating of the collection target document to the document database 100 by the control of the control portion 201, the document site of this collection target document is written to the collection completion list 204. In the example as shown in FIG. 3, only the document site of the collection completion document is recorded in the collection completion list 204 and managed. However, this example is not restrictive, the document site and the document ID or only the document ID may be recorded in the collection completion list 204.

The extraction portion 202 is given a document site from the control portion 201 and extracts a document being at that document site. The extraction portion 202 informs the control portion 201 that it has extracted the document. In response to this information, it becomes possible for the control portion 201 to change the contents of the collection target document list in the collection waiting list 203 and the contents of the collection target document list in the collection completion list 204.

The comparison portion 205 is given a document site of the collection target document from the control portion 201, retrieves the document database 100, and then judges whether of not the document site of the document corresponding to the collection target document exists in the document database 100. Furthermore, if the document site of the document corresponding to the collection target document exists, the comparison portion 205 retrieves the document database 100, and then, judges whether or not an same document exists at the document database 100 based on the same document information of that document.

Still further, if a same document relating to the document corresponding to the collection target document exists in the document database 100, the comparison portion 205 judges the document contents identity with regard to each same document extracted by the extraction portion 202.

The preservation portion 206 preserves a document given from the control portion 201 in a file, and at the same time, it writes a document ID, a preservation file name, a document site, and an same document information, which are related to the above given document, to the document database 100.

In the next, an explanation will be made about the document database. FIG. 4 is a table showing an example of the preservation contents of the document database 100.

As shown in FIG. 4, the document database 100 preserves the following items relating to each of the documents preserved by itself, that is, the document ID, the file name of the document preserved at the preservation portion 206 of the document collection apparatus 200, the document site, and the same document information indicating whether or not the same document relating to each of documents exists, in the document database 100. Besides, the document database 100 may preserve the data of the document.

In this embodiment, “Same document information” is the information indicating whether or not the document database 100 preserves a document of which the contents is same as that of a other document and at the same time, is the information indicating one representative document as elected from among a plurality of same documents judged as the same document

In this embodiment, for example, the same document having a minimum document ID is set to be a representative document from among a plurality of same documents.

In FIG. 4, for example, if the document with “document ID=1” and the document with “document ID=3” are different from each other in their document sites but are mutually same documents, the document with the minimum document ID i.e. the document with “document ID=1” becomes the representative document. In this case, the same document information of the document with “document ID=1” becomes “null” while the same document information of the document with “document ID=3” becomes the document ID of the representative document, that is, “1.”

Furthermore, in FIG. 4, if the document with “document ID=2” and the document with “document ID=4” are mutually same documents, the document with the minimum document ID i.e. the document with “document ID=2” becomes the representative document. In this case, the same document information of the document with “document ID=2” becomes “null” while the same document information of the document with “document ID=4” becomes the document ID of the representative document, that is, “2.”

However, “Same document information” is not limited to the examples as described above. That is, if a plurality of same documents exists in the document database 100 and it is possible to designate only one document from among them as a representative document, it may be possible to set a representative document by the other appropriate way. For example, it may be possible to preserve these two of same document information such that they correspond to respective documents, or it may be also possible to elect the newest same document (the same document collected latest) as the representative document In the next, there will be explained the internal structure of the document retrieval apparatus 300 along with the function thereof.

The input portion 301 takes in the retrieval condition as inputted and gives it to the DB retrieval portion 302. The input portion 301 is constituted, for example, by using users' operable keyboard, ten key, etc., or an input section for inputting the data or the like from an input apparatus through a network. The retrieval condition may be a character string in Japanese, English or other languages, a numeral string, a symbol string, a combined string of these, other various kinds of retrieval keywords, or a plurality of retrieval keywords different from each other.

The DB retrieval portion 302 receives the retrieval condition given from the input portion 301 and retrieves a document satisfying the given retrieval condition from the document database 100. The DB retrieval portion 302 takes out the document ID, the file name, the document site, and the same document information with regard to the document coming under the retrieval condition from the document database 100. The retrieval portion 302 takes out the document ID, the file name, the document site and the same document information with regard to the document coming under the retrieval condition from the document database 100 as the retrieval result and gives them to the coincidence detection portion 303.

The coincidence detection portion 303 receives the retrieval result from the DB retrieval portion 302 and judges whether or not the same documents exist in the retrieval result, based on its received retrieval result. If the same documents exist, the coincidence detection portion 303 selects only one representative document from among same documents and excludes the remaining same documents.

First of all, the coincidence detection portion 303 refers to the same document information of each document based on the retrieval result of the DB retrieval portion 302 and leaves only the documents of which the same document information is “null” and excludes the documents of which the same document information is other than “null.” In other words, the coincidence detection portion 303 selects the representative document from among documents having no same document as well as a plurality of same documents about which it is already known that they have the same documents, among documents included in the retrieval result.

In the next, the coincidence detection portion 303 further judge whether or not the same documents still exist in the retrieval result in which there are left documents having no same document as well as a representative document of plural same documents about which it is already known that they have the same documents. If it is made known from this judgment result that new same documents still exist, the coincidence detection portion 303 elects a representative document from among those same documents. Still, in this embodiment, the same document having a minimum document ID is set to be a representative document from among a plurality of same documents.

The coincidence detection portion 303 excludes other same documents based on the same document information and gives a document election result obtained by electing the representative document from among newly detected same documents to the output portion 305.

Furthermore, the coincidence detection portion 303 gives at least the information relating to plural same documents as newly detected as well as the information relating to the representative document elected from those same documents to the update portion 304.

When the coincidence detection portion 303 has elected the representative document from among the newly detected same documents, the update portion 304 updates the same document information of the document database 100.

In other words, when the coincidence detection portion 303 has elected the representative document from among the newly detected same documents, the update portion 304 does not change the same document information relating to the elected representative document (the document having the minimum document ID) to keep “null” as it is and changes the same document information relating to the other same documents than the representative document to the document ID of the representative document to preserve it in the document database 100.

Like this, by updating the same document information at the time of document retrieval, it becomes possible to reflect the document contents identity judgment of this time to the next document retrieval and/or document collection.

The output portion 305 outputs the document election result as inputted from the coincidence detection portion 303. To put it more concretely, when the coincidence detection portion 303 still newly detects same documents from among the remaining documents that are left as the document election result after the coincidence detection portion 303 deletes the documents based on the same document information, the output portion 305 outputs a representative document from among those newly detected same documents.

### (A-2) Operation of the First Embodiment

In the following, we first explain about the document collection operation of the document collection apparatus 200 and then, we move to the explanation about the document retrieval operation of the document retrieval apparatus 300.

### (A-2-1) Document Collection Operation

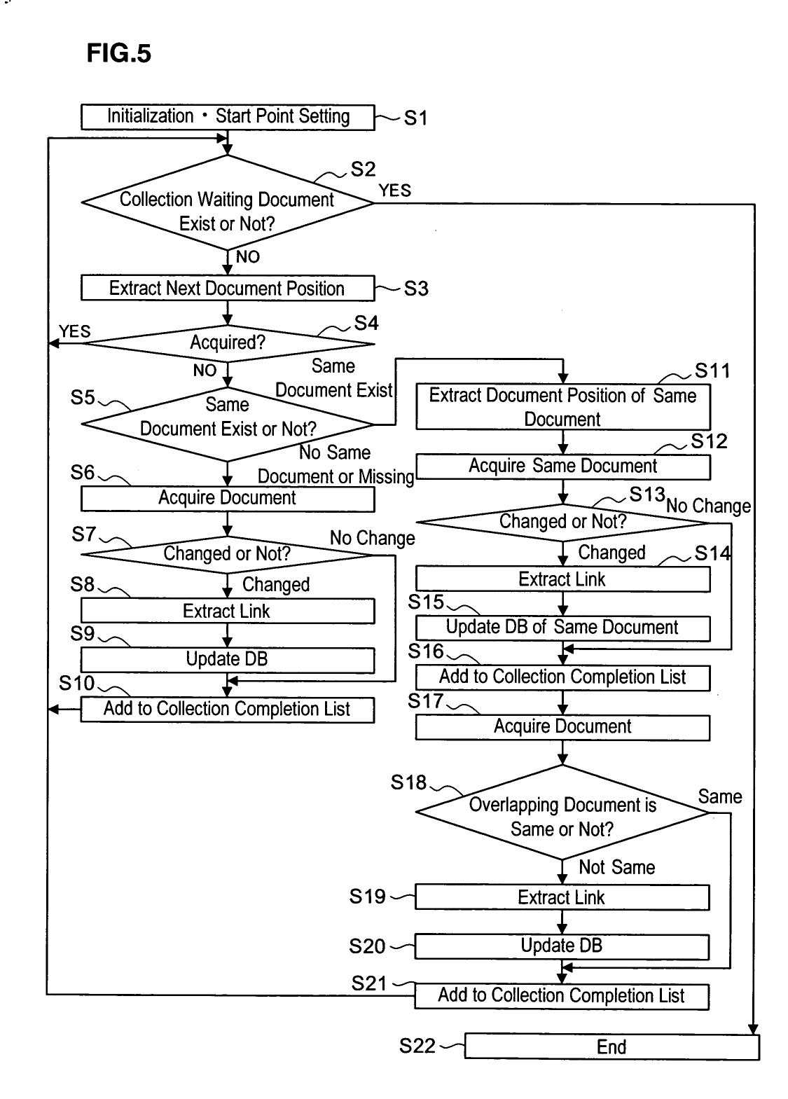

FIG. 5 is a flowchart showing the document collection operation of the document collection apparatus 200.

As shown in FIG. 5, at first, before starting the document collection operation, the collection waiting list 203 and the collection completion list 204 are initialized under the control of the control portion 201, thereby the collection target documents listed in the collection waiting list 203 and the collection completion documents listed in the collection completion list 204 being made empty (step S1).

The collection waiting list 203 and the collection completion list 204 being initialized like this, the control portion 202 writes the document site (e.g. the top page of a WEB page of URL etc.) of the document designated in advance as the start point to the collection waiting list 203. With this, the document site as the start point is held as a collection target in the collection waiting list 203 (step S1)

For example, if the document site as designated in advance is [http://www.oki.com/jp/] (corresponding to “document ID=1” in the document database 100 in FIG. 4), this document site is given to the collection waiting list 203.

In the next, the control portion 201 confirms whether or not the document site is listed in the collection waiting list 203 (step S2).

At this stage, if no document site is listed in the collection waiting list 203, the collection operation is terminated (step S22).

If one or more document sites are listed in the collection waiting list 203, the document sites are taken out in sequence by the control portion 201 according to the collection order of the collection document list (step S3).

For example, when only the above [http://www.oki.com/jp/] is listed as the start point in the collection waiting list, and if that document site as the start point is taken out, the collection target list becoming empty.

Furthermore, the control portion 201 collates the document site taken out from the collection waiting list 203 with the collection completion documents of the collection completion list 204 and judges whether or not the document site as taken out is the document that has been taken out already (step S4).

If a document at the document site taken out by the control portion 201 is a collection completion document, the collection operation is repeated by returning to the step S2.

If a document at the document site taken out by the control portion 201 is an collection incompletion document, it is retrieved whether or not a document site same as that document site exists in the document database 100 and further, it is judged whether or not an same document overlapping with the document at that document site exists in the documents database 100 (step S5).

In other words, the control portion 201 first retrieves whether or not a same document site same as the document site of the collection target document as taken out is preserved in the document database 100. Then, if the document site corresponding to the document site of that collection target document exists in the document database 100, the control portion 201 further proceeds to the step S11 and refers to the same document information corresponding to that document site.

On one hand, if the document site of the collection target document is not listed in the collection completion document list and the document site corresponding thereto does not exist in the document database 100 (i.e. being missing), the processing step is advanced to the step S6 without referring to the same document information.

If the same document information of the document in the document database 100, which corresponds to the document site of the collection target document, is “null,” the control portion 201 judges that the document has no same document in the document database 100 or judges that the document is a representative document from among a plurality of same documents. On one hand, if the above same document information includes a document ID of the other document, the control portion 201 judges that the document has an same document in the documents database 100.

For example, when it is assumed that the collection target document corresponds to the document ID=1, if the document database 100 as shown in FIG. 4 is retrieved with regard to the document site of the collection target document, it will be seen that the document database 100 preserves the document corresponding to the document site (the document ID=1) of the collection target document Accordingly, since the control portion 201 can confirm that the same document information of the document ID=1 is “null” in the document database 100, the control portion 201 can judge that the document database 100 preserves the collection target document (corresponds to document ID=1) and no same document exists. However, in the example as shown in FIG. 4, though the document of the document ID=1 and the document of the document ID=3 are set to be same documents, since the document of the document ID=1 is the representative document, the same document information of the document ID=1 is made “null.” As the result of this, it is judged that the document of the document ID=1 has no same document.

On one hand, when it is assumed that the collection target document corresponds to document ID=3, since the same document information of the document ID=3 is “1,” the control portion 201 can judge that the document corresponding to the collection target document exists in the document database 100 and the same document with regard to that document also exists in the same.

In the processing at (step S5), if it is judged that no same document corresponding to the collection target document exists in the document database 100 or judged that no document site corresponding to the same exists (being missing) in document database 100, the control portion 201 gives the document site of the collection target document to the extraction portion 202, which extracts a document at that document site.

If the collection target document extracted by the extraction portion 202 exists in the document database 100 but it is not listed in the collection completion list 204, the extracted document (collection target document) is given to the comparison portion 205, which compares the extracted document with the contents of the corresponding document in the document database 100 and judges whether or not the document contents have been changed (step S7).

Here, as a way of judging whether the document contents in the document database 100 is changed or not, it is possible to make use of the binary digit and/or character strings. For example, when comparing the binary statement of the extracted document with that of the documents in the document database 100, if both are same, it is judged that the document contents are not changed, and if both are different from each other, it is judged that the document contents are changed.

If it is judged that the document contents in the document database 100 are not changed, the processing step is advanced to the step S10 where the document concerned is added to the collection completion document list of the collection completion list 204 (step S10). To put it more concretely, the document site of the collected document is written to the collection completion list 204. As the result of this, it becomes impossible thereafter to collect the document with the same document site

In contrast to this, If it is judged that the document contents in the document database 100 are changed or judged that the document site of the collection target document is missing in the document database 100, the control portion 201 refers to one or two or more other documents linked to the extracted document (e.g. linked WEB page), extracts each document site of the other documents, and gives the extracted document sites of the other documents to the collection waiting list 203 (step S8).

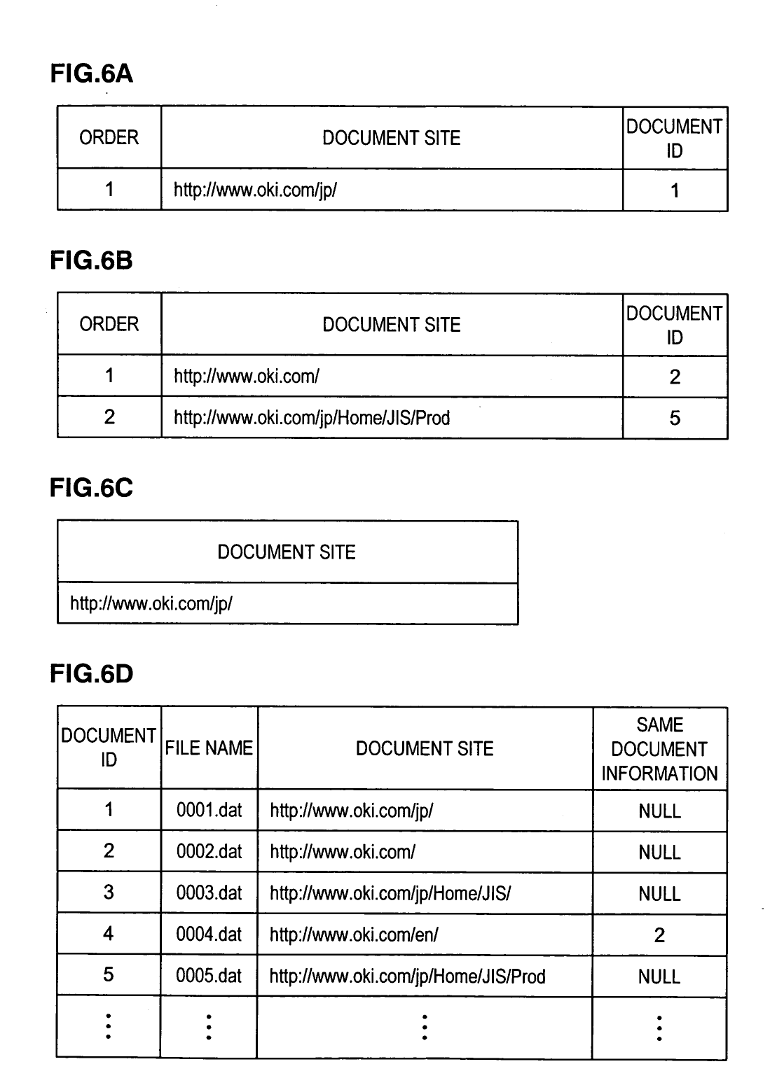

FIGS. 6A through 6D are tables for explaining the progress of the data management executed by respective constituents related with the document collecting operation. FIG. 6A shows a collection target document list of the collection waiting list 203 when designating the document site corresponding to the document ID=1 as a start point. For example, if it is judged that the contents of the document (document ID=1) corresponding to this start point is changed at the step S7, as shown in FIG. 6B, the document sites of other documents (the document ID=2 and 5 in this example) linked with the document (document ID=1) are extracted and added to the collection target document list of the collection waiting list 203. When the document sites of these other documents are added to the collection target document list of the collection waiting list 203, the collection operation is executed in sequence with regard to these other documents as the collection target documents.

When the extracted document is given to the preservation portion 206 from the control portion 201, the extracted document is preserved in a file of the preservation portion 206, that file name preserving this document, the document site, the document ID and the same document information are written to the document database 100 (step S9).

Here, the same document information is kept “null.” This is because no same document overlapping with the document corresponding to the extracted document exists in the document database 100. Also, if the document ID is not assigned yet, a new document ID is selected and given so as not to overlap with other document ID's.

When the above writing to the document database 100 by the preservation portion 206 is finished, the control portion 201 adds the effect that collection of the document concerned has been completed to the collection completion document list of the collection completion list 204 (step FIG. 6C shows the collection completion document list of the collection completion list 204. As shown in FIG. 6C, when the writing process by the preservation portion 206 to the document database 100 is over, each document site of the documents concerned are added to the collection completion list 204 by the control portion 201, thereby they becoming collection completion documents. As the result of this, no document with the same document site can be collected hereafter.

Then, the processing step goes back to (step S5), in which it is judged whether or not there exist in the document database 100 a plurality of same documents overlapping with the document at the document site of the collection target document. If it judged that they exist, the document sites of the same document in the document database 100 are taken out by the control portion 201 (step S11).

For example, when the document site of the collection target corresponding to the document ID=3, the document of document ID=1 exists, in the document database 100, as a same document corresponding to the document ID=3.

In other words, in the document database 100, there exist the collection target document (document ID=3) and the document of the document ID=1 which is the same document (respective document) as that target document.

In this case, the control position 201 takes out the document site ([http://www.oki.com/jp/]) of the same document (document ID=1) which is the representative document of the collection target document (document ID=3).

The document site of the same document (representative document) taken out from the document database 100 by the control portion 201 is given to the extraction portion 202 and the same document (representative document) at that document site is extracted (step S12).

If the same document (representative document) is extracted by the extraction portion and it is judged by referring to the collection completion list 204 that the same document as concerned is not yet collected, the same document as concerned is given to the comparison portion 205 and then, it is judged whether the contents of the document in the document database 100 is changed or not with regard to that extracted same document (step S13).

Here, as a way of judging whether the document contents in the document database 100 is changed or not, it is possible to make use of the binary digit and/or character strings. For example, when comparing the binary statement of the extracted same document (representative document) with that of the document (representative document) in the document database 100, if both binary statements are same, it is judged that the document contents are not changed, and if both are different from each other, it is judged that the document contents are changed.

If it is judged that the document contents in the document database 100 are not changed, the processing step is advanced to (step S16) where the document concerned is added to the collection completion document list of the collection completion list 204 (step S16).

In contrast to this, If it is judged that the document contents in the document database 100 are changed or judged, the control portion 201 refers to one or two or more other documents linked to the extracted same document (representative document), extracts each document site of the other documents, and gives the extracted document sites of the other documents to the collection waiting list 203 (step S14). When the document sites of these other documents are given to the collection waiting list 203, they are held as the collection target document list and the collection operation is executed in sequence with regard to these other documents as the collection target documents.

When the extracted same document (representative document) is given to the preservation portion 206 from the control portion 201, the given document (representative document) is preserved in a file of the preservation portion 206, and that file name preserving this document, the document site, the document ID and the same document information are written to the document database 100 (step S15).

Since the same document information with regard to the same document (cores. to document ID=1) as the representative document is updated, the same document information is kept as “null.”

When the above writing to the document database 100 by the preservation portion 206 is finished, the control portion 201 adds the effect that collection of the document concerned (representative document) has been completed to the collection completion document list of the collection completion list 204 to (step S16).

When the same document (representative document) is extracted by the way as described above, the document site of the collection target document (document ID=3) is given to the extraction portion 202 and the collection target document (document ID=3) is extracted (step S17).

When the collection target document (document ID=3) is extracted, the document contents of the extracted collection target document (document ID=3) is compared with the contents of the same document (representative document: document ID=1), it is judged whether or not both contents are same (step S18).

Here, the judgment on document contents identity between the document contents of the collection target document (document ID=3) and the document contents of the same document (representative document document ID=1) is executed for example by comparing the binary statement of the collection target document with that of the same document. If both binary statements are same, it is judged that the document contents are same, and if both are different from each other, it is judged that the document contents are non same.

When the judgment result on the document contents identity by the comparison portion 205 is identical (same), the processing step is advanced to (step S21) and the control portion 201 adds the effect that collection of the collection target document (document ID=3) concerned has been completed to the collection completion document list of the collection completion list 204 (step S21). To put it more concretely, information on the collection target document (document ID=3) concerned is written to the collection completion list 204.

When the judgment result on the document contents identity by the comparison portion 205 is not identical (not same), the control portion 201 refers to one or two or more other documents linked to that document, extracts each document site of the other documents, and gives the extracted document sites of the other documents to the collection waiting list 203 (step S19).

In the next, the collection target document is given to the preservation portion 206 by the control portion 201 and is preserved in a file of the preservation portion 206. The file name file preserving this document, the document site, the document ID and the same document information are written to the document database 100 (step S20).

In this case, since it is judged that the document contents of the collection target document (document ID=3) is not same as the document contents of the representative documents (document ID=1), as shown in FIG. 4 and FIG. 6D the same document information of the collection target document concerned (document ID=3) is changed from “1” to “null” When the writing to the document database 100 is executed by the preservation portion 206, the control portion 201 adds the effect that collection of the collection target document concerned (document ID=3) has been completed to the collection completion document list of the collection completion list 204 (S21).

As described above, the document collection apparatus 200 repeats the collection operation until the document site included in the collection target document list of the collection wailing list 203 becomes empty and the collection operation is terminated when the collection target document list becomes empty.

### (A-2-2) Document Retrieval Operation

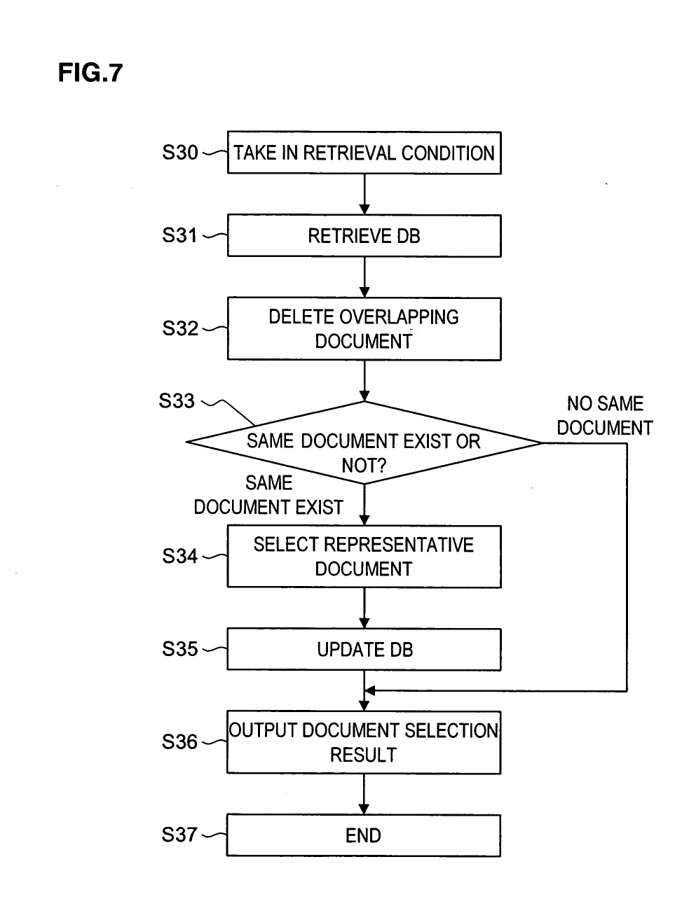

In the next, the document retrieval operation by the document retrieval apparatus 300 will be described with reference to FIG. 7. This figure is a flowchart showing the document retrieval operation.

As shown in FIG. 7, the input portion 301 takes in a retrieval condition as inputted by a user, for example, and gives it to the DB retrieval portion 302 (step S30).

Being given the retrieval condition, the DB retrieval portion 302 retrieves the document database 100 and takes out a document satisfying the retrieval condition therefrom. Then, the document as taken out is given to the coincidence detection portion 303 as a retrieval result (step S31).

Receiving the retrieval result from the DB retrieval portion 302, the coincidence detection portion 303 refers to the same document information of the documents included in the retrieval result and leaves the document of which the same document information is “null.” Then, other documents than that are deleted from the retrieval result (step S32). Through this processing, it becomes possible to leave only one document (representative document) from among a plurality of overlapping same documents and to exclude other overlapping documents

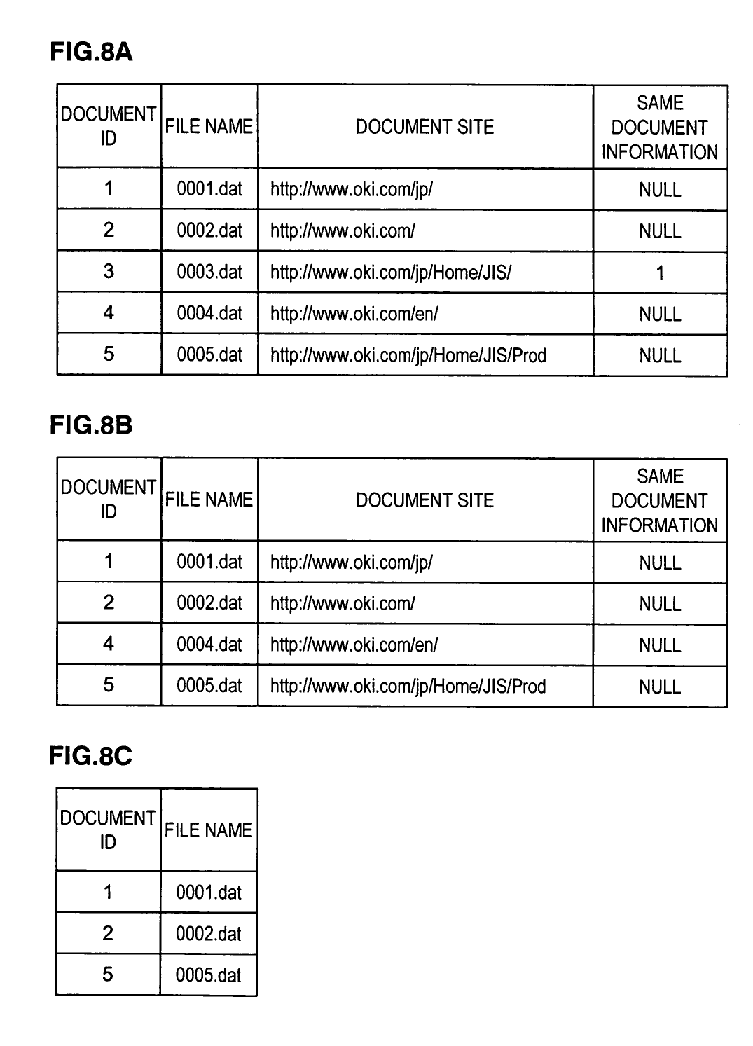

FIGS. 8A to 8C are tables showing an example of the retrieval result obtained by a DB retrieval portion 302. The coincidence detection portion 303 deletes the document of the document ID=3 of which the same document information is “1” from the retrieval result (FIG. 8A) obtained by the DB retrieval portion 302.

Furthermore, after deleting overlapping documents at the step S32, the coincidence detection portion 303 takes out each of the remaining documents from the file position preserving it and executes the document contents identity judgment with regard to whether the same documents exist among remaining documents or not (step S33).

If it is judged that no same document exists among the remaining documents, the coincidence detection portion 303 gives each of these documents as a document election result to the output portion 305, which in turn outputs these documents (step S36). This output portion 305 may display the document site list of the elected documents or the document contents list of the elected documents.

Besides, if it is judged at the step S33 that same documents exist among the remaining documents, the coincidence detection portion 303 elects one representative document from among a plurality of documents judged to be same (step S34).

For example, in the result as shown in FIG. 8B, if the coincidence detection portion 303 judges that the document ID=2 is same as the document ID=4, a document of the minimum document ID is elected as a representative document, in other words, the coincidence detection 303 elects the document of the document ID=2 as the representative document.

Furthermore, when the representative document is elected as described above, the coincidence detection portion 303 gives the update portion 304 at least the information with regard to a plurality of the documents as judged to be same documents (same document group) as well as the information with respect to the representative document elected from among same documents

The update portion 304 does not change the same document information of the elected representative document and keeps it “null” as it is. Besides, with regard to the same documents other than the representative document, the update portion 304 updates the document database 100 such that the same document information is changed to the document ID of the representative document (step S35).

Furthermore, the coincidence detection portion 303 gives the document having no same document and the representative document elected from among same documents as the document election result (see FIG. 8C) to the output portion 305, which in turn outputs this document election result (step S36).

In the way as described above, the document is retrieved based on the inputted retrieval condition, thereby the document retrieval operation being terminated (step S37).

### (A-3) Effects of the First Embodiment

As has been described above, according to the first embodiment of the invention, the following advantageous effects are obtainable. That is, it becomes possible to manage even the same document information related to documents preserved in the document database 100. When the document collection apparatus 200 collects the collection target document, it becomes possible to affirm based on the same document information whether the same documents exist or not. Furthermore, it becomes possible to update the same document information in response to the change in the document contents. Accordingly, the load in the document contents identity judgment is reduced, the document management in the document database 100 is made effective and also, the load in the document retrieval process is far reduced.

According to the first embodiment, when the document retrieval is executed by the document retrieval apparatus 300, the same documents are deleted based on the same document information and if new same documents are detected, the same document information is updated. Therefore, the load in the document contents identity judgment is reduced, the frequency of the document retrieval to be executed is also reduced, and it becomes possible to realize the high speed document retrieval and the reduction in the load of the retrieval processing.

### (B) Second Embodiment

In the next, the second embodiment relating to a document collection apparatus, a document retrieval apparatus and a document collection/retrieval system according to the invention will be explained with reference to the drawings.

Similar to the first embodiment, the second embodiment will be also explained about the application of the invention to the case of retrieving the document (HTML document) on the basis of the retrieval conditions as inputted by using the Internet, for example.

### (B-1) Constitution of the Second Embodiment

A point of difference between the first embodiment and the second embodiment exists in the point that the document collection/retrieval system weights each document having overlapping same documents with a weight corresponding to the number of same documents at the time of executing the document collection and/or the document retrieval and also manages that weight on each document.

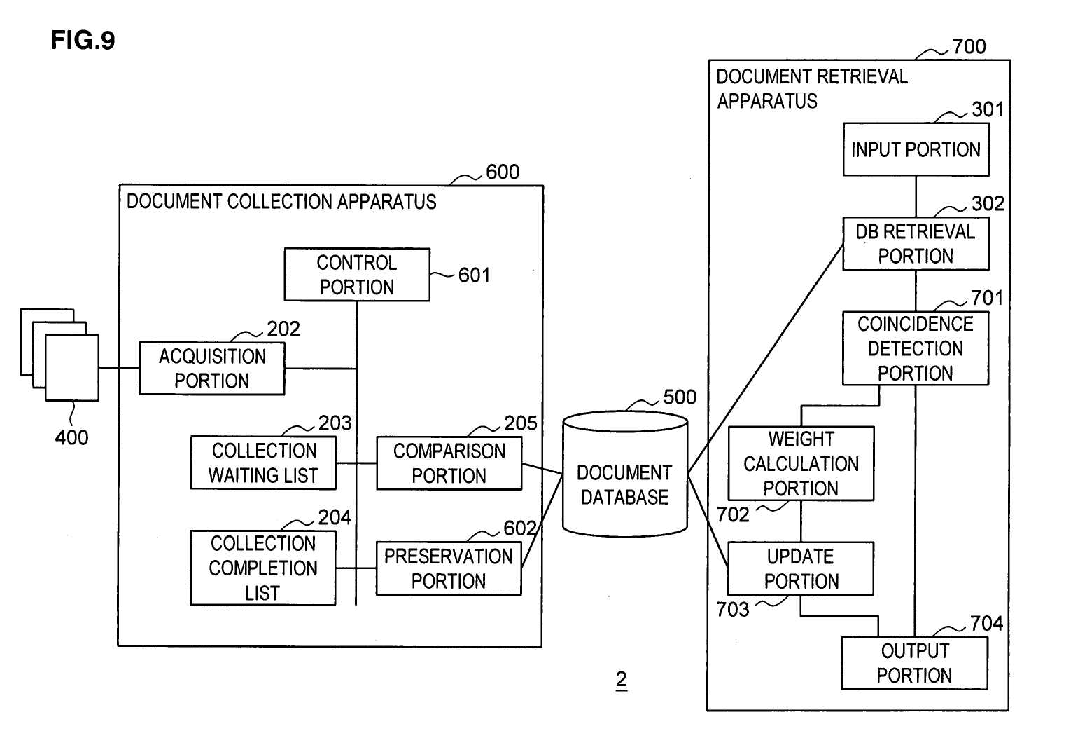

FIG. 9 is a structural block diagram showing an entire structure of the document collection/retrieval system 2 according to the second embodiment.

In this figure, a constituent corresponding to the constituent as already described in connection with the first embodiment in FIG. 1 is designated with a like reference numeral or mark. Besides, in the following, there will be omitted the explanation about the function of the constituent related to the first embodiment as shown in FIG. 1 while there will be described in detail the function of the constituent peculiar to the second embodiment.

The document database 500 preserves the file name, the document site, the same document information and the weight information of each document as preserved by the document database itself.

The weight information is the information with respect to a document having a same document To up it more in detail, the weight information is the information indicating how many same documents each document has. In this embodiment, for example, the weight information is expressed by a fraction “1/total number of same documents” on each same document group. For example, if there is no document having same contents, the total number of same document is “1,” thus the weight information of the document concerned becoming “1/1=1.” If there are two documents having the same contents, the total number of same documents is “2,” thus the weight information of each document concerned becoming “1/2=0.5.” If there are three documents having the same contents, the number of total same documents is “3,” thus the weight information of each document concerned becoming “1/3=0.33 . . . . ”

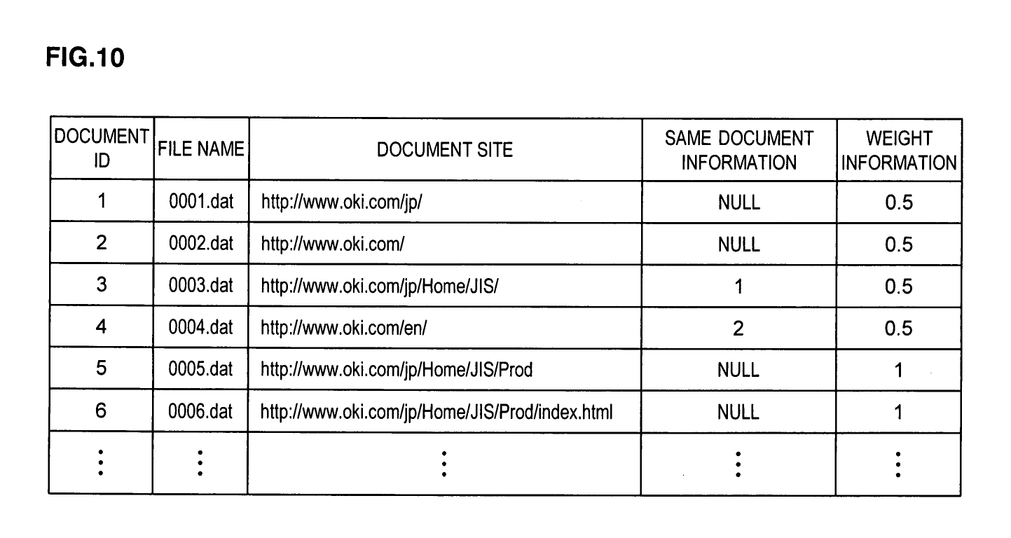

FIG. 10 is a table showing an example of preservation contents of the document database 500. In this figure, since “document ID=1” and “document ID=3” are same documents and the total number of the same documents is “2,” the weight information of “document ID=1”, and “document ID=3” becomes “0.5,” respectively. Besides, since “document ID=2” and “document ID=4” are same documents and the total number of the same documents is “2,” the weight information of “document ID=2” and “document ID=4” becomes “0.5,” respectively.

In the document collection apparatus 600, for example, the control portion 601 and the preservation portion 602 have different functions from corresponding portions 201 and 206 in the document apparatus 200 in the first embodiment. Besides, a preservation document affirmation section is constituted by the control portion 601 and the comparison portion 205, for example. A document collection section is constituted by the control portion 201 and the extraction portion 202, for example. A same document existence affirmation section is constituted by the control portion 601 and the comparison portion 205, for example. A document extraction section is constituted by the control portion 601 and the extraction portion 202, for example. A document contents judgment section is constituted by the control portion 601 and the comparison portion 205, for example. A document information update section is constituted by the control portion 601 and the preservation portion 206, for example. A representative document election section is constituted by the control portion 601 and the comparison portion 205, for example.

When the collection target document is not listed in the collection completion list 204 and the document corresponding to this the collection target document has no same document in the document database 500, the control portion 601 updates the weight information of each same document Like this, with regard to the document which has been judged to be an same document so far, if it is judged that the contents of that document is changed at the time of document collection, the control portion 601 updates the weight information.

If it is noted from the result of the document contents identity judgment by the comparison portion 205 that there is changed the contents of the document that has been preserved as an same document, the preservation portion 602 updates the weight information and the same document information of the document database 500 under the control of the control portion 601.

The document retrieval apparatus 700 is newly provided with a weight calculation portion 702. A coincidence detection portion 701, an update portion 703 and an output portion 305 are respectively different in their functions from the identically named portions in the first embodiment Besides, a document retrieval section is constituted by the DB retrieval portion 302, for example. A same document deletion section is constituted by the coincidence detection portion 701, for example. A retrieved document contents judgment section of retrieved is constituted by the coincidence detection portion 701, for example. A retrieved document information update section is constituted by the weight calculation portion 702 and the update portion 703, for example. A retrieval result output section is constituted by the output portion 305, for example. A representative document election section is constituted by the coincidence detection portion 701, for example.

The weight calculation portion 702 receives the number of documents having same document contents (refers to as “same document number” hereinafter) from the coincidence detection portion 701 on respective document contents and calculates the weight information of the same documents on respective document contents based on this same document number. Then, the weight calculation portion 702 gives the calculation result of the weight information to the update portion 703.

The coincidence detection portion 701 detects the same documents based on the retrieval result from the DB retrieval portion 302 and elects the representative document from among those same documents. Besides, if the weight information of the elected representative document is “1,” the coincidence detection portion 701 gives the same document number of the elected representative document to the weight calculation portion 702.

The coincidence detection portion 701 is different from the coincidence detection portion 303 in the first embodiment in the following point. That is, the latter (303) deletes, from the retrieval result, the documents of which the same document information is other than “null” while the former (701) does not delete any same document. Besides, if the elected

In short, the coincidence detection portion 701 detects all of the documents having the same document on respective document contents thereof, calculates the same document number on respective document contents, and gives this same document number to the weight calculation portion 702, thereby inflecting the same document number to the weight calculation by the weight calculation portion 702.

Of course, the coincidence detection portion 701 calculates the same document number on respective document contents referring to the same document information and also taking account of the known information about those that already have same documents.

When the coincidence detection portion 701 elects the representative document from among same documents as detected on respective document contents, the update portion 703 updates the same document information and the weight information of the document database 500 on respective document contents.

### (B-2) Operation of the First Embodiment

In the following, we first explain about the document collection operation of the document collection apparatus 600 and then, we move to the explanation about the document retrieval operation of the document retrieval apparatus 700.

### (B-2-1) Document Collection Operation

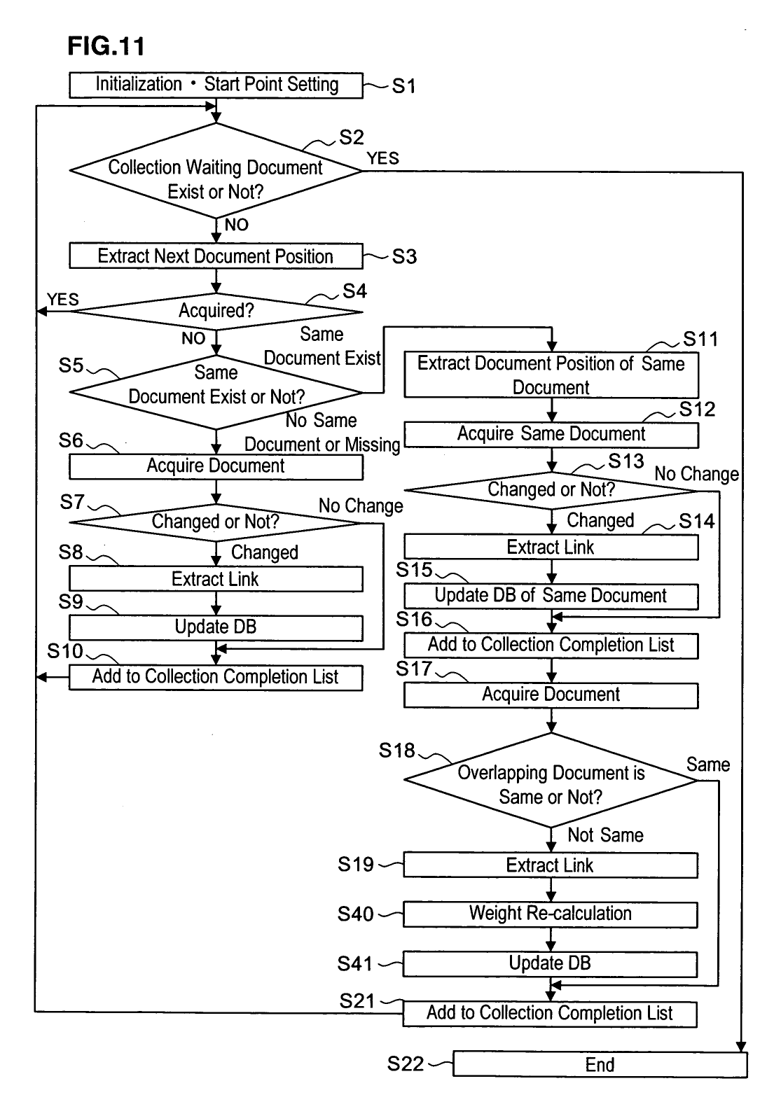

FIG. 11 is a flowchart showing the document collecting operation of the document collection apparatus 600. In this figure, the operation corresponding to the operation as described in the first embodiment is designated by a corresponding reference mark.

The operation from the step of initializing the document collection apparatus 600 and setting the start point (step S1) to the step of judging whether or not the same document of the document corresponding to the collection target document exists in the document database 500 (step S5), is approximately identical to the operation as explained in the first embodiment, so that the explanation thereabout will be omitted herein.

Furthermore, in the step S5, the inquiry operation on whether the same document of the document corresponding to the collection target document exists or not or is missing in the document database 500 (steps S6 to S10) is also same as the operation in the first embodiment, so that the explanation is omitted herein.

In the step S5, if a same document of the document corresponding to the collection target document exists in the document database 500, each same document is extracted based on each document site thereof. Furthermore, the collection target document concerned is also extracted based on the document site thereof (steps S11 to S17).

When each same document and the collection target document are extracted through the processing steps up to the step S17, it is judged by the comparison portion 205 whether or not the document contents of the collection target document and the contents of each same document are same each other (step S18). If it is judged that the document contents of each same document are same, the processing is advance to the step S21.

The extraction operation of each same document and the collection target document which is executed through the processing steps of S1 to S17, and the judgment operation on the document contents identity as executed at the processing steps S18 and S19 are previously explained in connection with the first embodiment, thus more detailed explanation being omitted.

In the step S18, if it is judged that the document contents of each same document are not same, the weight information with regard to each same document is recalculated by the control portion 601 (step S40), thus the weight information and the same document information of the document database 500 being updated (step 41).

In the next, the document collection operation is explained by using an example as shown in FIG. 10 wherein the document database 500 preserves the documents as listed therein. In this example as shown in FIG. 10, if the collection target document is a document corresponding to the document ID=3, the document of the document ID=1 exists as the same document of the collection target documents.

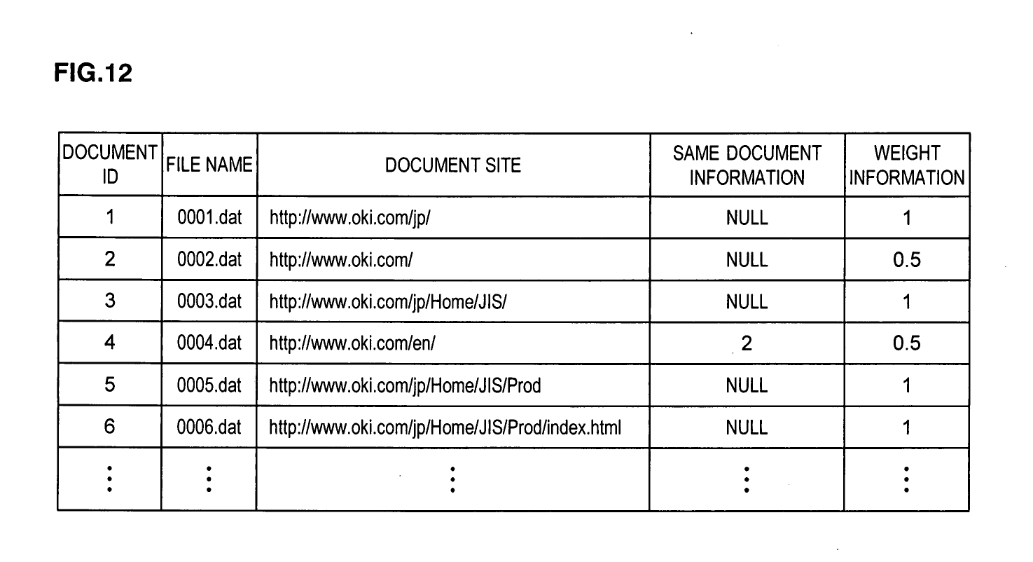

Thereafter, if the document contents of each same document (document ID's=1 and 3) are changed and it is judged by the comparison portion 205 that the contents are mutually different from each other at the step S18, the same document information of each documents of the document ID's=1 and 3 is updated to be “null” as shown in FIG. 12, and at the same time, the weight information is updated from “0.5” to “1.”

When the updating of the document database 500 is completed, as described in the first embodiment, the collection completion document list of the document completion list 204 is revised (step S21). In the way as described above, the document collection operation is repeated until the document site column listing the collection target documents becomes empty.

### (B-2-2) Document Retrieval Operation

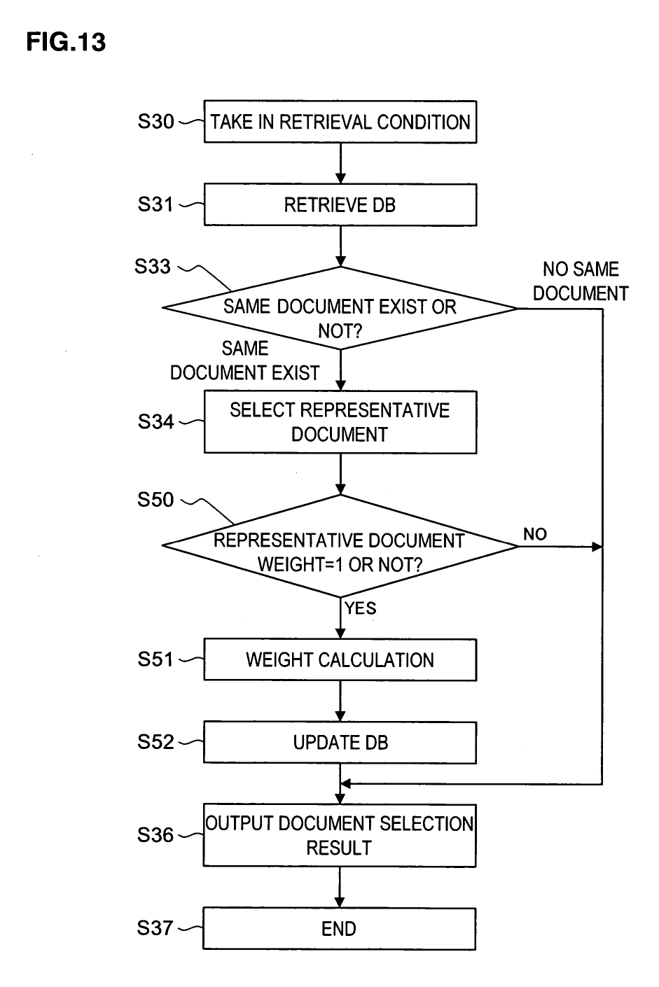

In the next, the document retrieval operation by the document retrieval apparatus 700 will be described with reference to a flowchart as shown in FIG. 13. In this figure, the operation corresponding to the operation as described in the first embodiment is designated by a corresponding reference mark.

As shown in FIG. 13, since the operation (steps S30 and S31) wherein the DB retrieval portion 302 first takes in a retrieval condition as inputted, retrieves the document database 500 to take out the document satisfying the retrieval condition, and gives it to the coincidence detection portion 701 as a retrieval result, is approximately identical to the operation as has been explained in connection with the first embodiment, thus the explanation thereabout being omitted.

Receiving the retrieval result from the DB retrieval portion, the coincidence detection portion 702 executes the document contents identity judgment about with regard to each document based on the received retrieval result (step S33). If the document is judged to be a document having no same document, the processing step advances to the step S36.

The coincidence detection portion 701 elects a representative document from among documents each of which is judged to be a document having a same document by the coincidence detection portion 701 based on the retrieval result. In this embodiment, the document of the minimum document ID is elected as a representative document.

Furthermore, electing the representative document, the coincidence detection portion 701 affirms whether the weight information of the representative document is “1”, or not. If it is not “1,” the processing step is advanced to step S36. On one hand, if it is “1,” the same document number is calculated on respective document contents, the same document number on respective document contents is given to the weight calculation portion 702 (step S50).

When the same document number on respective document contents is given to the weight calculation portion 702 from coincidence detection portion 701, the weight information on respective document contents is calculated by the weight calculation portion 702 (step S51).

A result of the weight calculation by the weight calculation portion 702 is given to the update portion 703, which in turn updates the weight information and the same document information regarding the same document in the database 500 on respective document contents thereof.

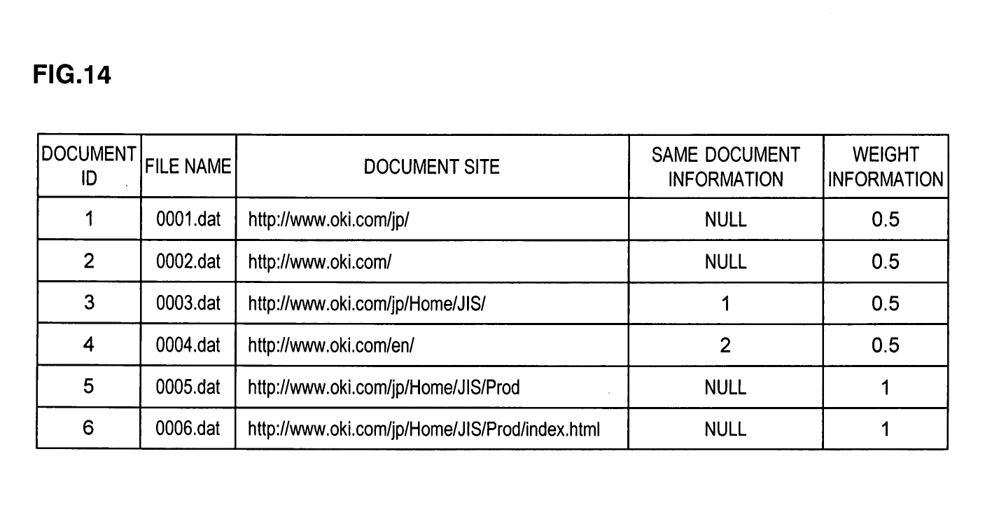

Here, let us explain about the retrieval operation referring to an example. FIG. 14 is a table showing an example of the retrieval result obtained by a DB retrieval portion 302. Besides, in this example, let us assume that the documents of the document ID's=5 and 6 are judged to be same documents by the coincidence detection portion 701.

The coincidence detection portion 701 elects the document of the younger document ID=5 as a representative document from these two same documents of the document ID's=5 and 6 (step S34). Besides, the coincidence detection portion 701 refers to the weight information of the document of document ID=5 and affirms that the weight information is “1” (step S50).

Furthermore, since two documents of the document ID's=5 and 6 are same documents, the coincidence detection portion 701 gives the same document number “2” to the weight calculation portion 702, which in turn calculates the weight “0.5” on the respective document contents of the documents of document ID's=5 and 6 based on the same document number “2” (step S51).

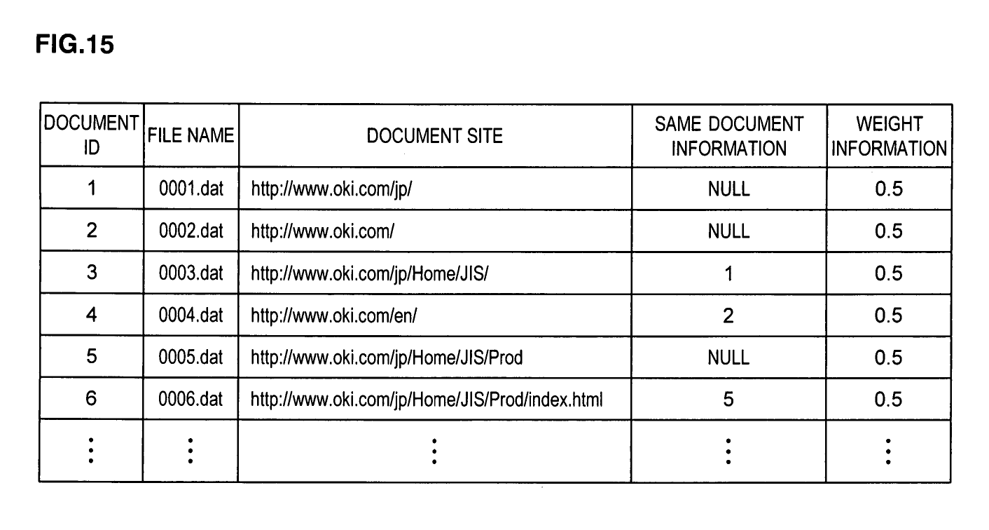

The calculation result by the weight calculation portion 702 is given to the update portion 703, which in turn updates the same document information and the weight information to read “null” and “0.5,” respectively, with regard to the document of the document ID=5 in the document database 500, and also updates the same document information and the weight information to read “5” and “0.5,” respectively, with regard to the document of the document ID=6 in the document database 500 as shown in FIGS. 10 and 15 (step S52).

In the way like this, the updating of the document database 500 is completed and the document election result is outputted from the output portion 704, thereby the document retrieval operation being terminated (step S37).

In the output of the document election result at the step S36, all the documents retrieved at the step S31 are displayed along with the weight information corresponding thereto. Because of this, the user can understand whether or not the same document exists in the retrieved documents, and how many same documents exist in the retrieved documents. In other words, the user can grasp that if the weight information of the document as displayed is “1,” no same document exists, and also that if the weight information of the document as displayed is other than “1,” the same document exists. Furthermore, the user can know that if the weight information of the document as displayed is “0.5,” two same document exist and that if the weight information of the document as displayed is “0.33 . . . ,” three same document exist. Like this, the user can recognize the number of same documents included in the retrieval result based on the magnitude of the weight information.

### (B-3) Effects of the Second Embodiment

As described above, according to this embodiment, there can be obtained the same effects as those that have been explained in connection with the first embodiment.

Furthermore, according to this embodiment, at the time of executing the document retrieval by the document retrieval apparatus 600, since the coincidence detection portion 701 does not delete the same document from the retrieval result of DB retrieval portion 302, it becomes possible to shorten the period of time spent for deleting the same documents. Besides, since the same document number as calculated can be reflected to the weight calculation, the user can grasp the number of overlapping documents with ease and convenience.

As has been discussed so far, according to the document collection apparatus, document retrieval apparatus and document collection/retrieval system as discussed in connection with the first and second embodiments of the invention, the processing load related to the document retrieval can be reduced. Furthermore, it becomes possible to reflect the updating of the document contents at the execution time of the document retrieval and the document collection to the document contents identity judgment at the next execution time of the document retrieval and the document collection. Still further, it becomes possible to execute the document retrieval processing and the document collection processing at a high speed.

While the invention has been shown and described in detail with respect to preferred embodiments, it is needless to say that the present invention is not limited to those examples. It is apparent that persons skilled in the art make various changes and modifications within the category of technical thoughts as recited in the scope of claim for patent, and it is understood that those changes and modifications naturally belong to the technical scope of the invention.

### (C) Other Embodiments

(C-1) In the above first and second embodiments as described above, while the explanation has been made about the document collection/retrieval system making use of the internet, the invention is widely applicable to various cases without being limited to this example. Besides, while the explanation has been made about the case where the collection/retrieval target document is the HTML document constituting a WEB page, other documents, papers or the like may become the collection/retrieval target. Furthermore, while the explanation has been made about the case where the URL is used as an example of a document site, an arbitrary document site may be usable if it can specify the site of the document.

(C-2) In the first and second embodiments as described above, while the document site designated in advance is used as a stat point at the time of starting the document collection operation, it may be possible for the document collection apparatus 200 or 600 to take out a document site as preserved in the document databases 100 or 500 and to use it as the start point in the document collection processing of the second time and thereafter.

(C-3) In the first and second embodiments as described above, while the document contents identity is judged simply based on whether the binary statements of two documents coincide with each other or not, it may be possible to utilize other things, if they are good for the document contents identity judgment, for example, the number of words constituting the document, the document conformity • appearance frequency of a word which are obtained from the statistical probability standpoint and other statistical probability result.

(C-4) In the first and second embodiments as described above, while it is explained that the same document information related to the representative document elected from among the same documents is “null” it may be possible to adopt other way, if it can clearly distinguish the representative document from the other same documents. For example, it may be possible to incorporate the document ID of the representative document itself into the same document information and to show it therein. In this case, however, it comes to exclude the representative document from the same documents at the time of document retrieval (step S36 in FIG. 7).

(C-5) In the first embodiments as described above, the document retrieval is explained by using an example where at the time of executing the document retrieval, the coincidence detection portion 303 deletes the same document from the retrieval result. However, it would be possible to remove this step of deleting same document by the coincidence detection portion 303, if it is possible to provide a coincident detection portion 303 which does not retrieve any same document. Actually, this is possible, for example, if changing the retrieval condition such that the coincidence detection portion 303 does not retrieve the same documents or if flagging the retrieval target document or the non-retrieval target document, from the beginning.

(C-6) In the second embodiments as described above, while in the weight calculation, the weight information is expressed in the form of “1/same document number,” it may be possible to use the weight information taking account of the document contents.

1. A document collection apparatus preserving document data collected from a outside apparatus in a document database which preserves same document information indicating whether or not same document data having same document contents exist, such that the same document information is related to each document data, comprising:
a preservation document affirmation section, which affirms whether or not document data corresponding to collection target document data is preserved in the document database;
a same document existence affirmation section, which affirms whether or not same document data of the document data corresponding to the document collection target document data exists in the document database based on the same document information of the document data corresponding to the collection target document data, when the document data corresponding to the collection target document data is preserved in the document database;
a document extraction section, which extracts the collection target document data and the same document data of the document data corresponding to the collection target document data from the outside apparatus, when the same document data of the document data corresponding to the collection target document data exists in the document database;
a document contents judgment section, which judges whether or not document contents of the extracted collection target document data and document contents of the extracted same document data of the document data corresponding to the collection target documents data are same; and
a document information update section, which updates the same document information relating to the extracted collection target document data and the extracted same document data of the document data corresponding to the collection target document based on the judgment result of the document contents judgment section.

2. A document collection apparatus according to claim 1, wherein the document database preserves representative document information indicative of representative document data selected from the same document data having same document contents, such that the representative document information is related to the each same document data,
the document collection apparatus is further provided with a representative document election section, which elects the representative document data from the same document data which are judged that their document contents are same by the document contents judgment section, and
the document information update section updates the representative document information with regard to the same document data which is judged that their document contents are same by the document contents judgment section, based on the election result of the representative documents election section.

3. A document collection apparatus according to claim 1, wherein the document database preserves weight information related to the same document data of which document contents are same, such that the weight information is related to the each same document data, and
the document information update section updates the weight information based on the judgment result of the document contents judgment section.

4. A document collection apparatus according to claim 2, wherein the document database preserves the weight information related to the same document data of which the document contents are same, such that the weight information is related to the each same document data, and
the document information update section updates the weight information based on the judgment result of the document contents judgment section.

5. A document retrieval apparatus retrieving the document data satisfying a retrieval condition as inputted, from a document database which preserves same document information indicating whether or not same document data having same document contents exist, such that the same document information is related to each document data, comprising:
a document retrieval section, which retrieves the document data satisfying the retrieval condition from the document database;
a same document deletion section, which judges whether or not the same document data exist among the document data retrieved by the document retrieval section, based on the same document information of the document data retrieved by the document retrieval section, and leaves only one same document data and deletes other same document data among the same document data if the same document data exists;
a retrieval document contents judgment section, which judges whether document contents of the document data except the same document data deleted by the same document deletion section among the document data retrieved by the document retrieval section are same or not;
a retrieval document information update section, which updates the same document information related to the document data based on the judgment result by the retrieval document contents judgment section; and
a retrieval result output section, which outputs the document election result based on the judgment result by the retrieval document contents judgment section.

6. A document retrieval apparatus according to claim 5, wherein the document database preserves representative document information indicative of representative document data selected from the same document data having same document contents, such that the representative document information is related to the each same document data, and
the same document deletion section leaves only the representative document data elected from among the same document data based on the representative document information of the each document data retrieved by the document retrieval section, and deletes other same document data.

7. A document retrieval apparatus according to claim 6, further comprising a representative document election section, which elects the representative document data from the same document data which are judged that their document contents are same by the retrieval document contents judgment section, and
the retrieval document information update section updates the representative document information with regard to the same document data which are judged that their document contents are same by the retrieval document contents judgment section based on the election result of the represent document election section.

8. A document retrieval apparatus retrieving the document data satisfying a retrieval condition as inputted, from a document database which preserves same document information indicating whether or not same document data having same document contents exist, and weight information related to the same document data, such that the same document information and the weight information are related to each document data, comprising:
a document retrieval section, which retrieves the documents data satisfying the retrieval condition from the document database;
a retrieval document contents judgment section, which judges whether document contents of the document data retrieved by the document retrieval section are sama or not;
a retrieval document information update section, which updates the same document information and the weight information related to the document data based on the judgment result by the retrieval document contents judgment section; and
a retrieval result output section, which outputs the document data retrieved by the document retrieval section, along with the weight information of the document data retrieved by the document retrieval section.

9. A document collection/retrieval system having a document database which preserves same document information indicating whether or not same document data having the same document contents exist, such that the same document information is related to each document data, a document collection apparatus preserving the document data collected from a outside apparatus in the document database, and a documents retrieval apparatus retrieving the document data satisfying the retrieval condition as inputted from the database, wherein
the document collection apparatus comprising:
a preservation document affirmation section, which affirms whether or not document data corresponding to collection target document data is preserved in the document database;
a same document existence affirmation section, which affirms whether or not same document data of the document data corresponding to the document collection target document data exists in the document database based on the same document information of the document data corresponding to the collection target document data, when the document data corresponding to the collection target document data is preserved in the document database;
a document extraction section, which extracts the collection target document data and the same document data of the document data corresponding to the collection target document data from the outside apparatus, when the same document data of the document data corresponding to the collection target document data exists in the document database;
a document contents judgment section, which judges whether or not document contents of the extracted collection target document data and document contents of the extracted same document data of the document data corresponding to the collection target documents data are same; and
a document information update section, which updates the same document information relating to the extracted collection target document data and the extracted same document data of the document data corresponding to the collection target document based on the judgment result of the document contents judgment section, and
the document retrieval apparatus comprising:
a document retrieval section, which retrieves the document data satisfying the retrieval condition from the document database;
a same document deletion section, which judges whether or not the same document data exist among the document data retrieved by the document retrieval section, based on the same document information of the document data retrieved by the document retrieval section, and leaves only one same document data and deletes other same document data among the same document data if the same document data exists;
a retrieval document contents judgment section, which judges whether document contents of the document data except the same document data deleted by the same document deletion section among the document data retrieved by the document retrieval section are same or not;
a retrieval document information update section, which updates the same document information related to the document data based on the judgment result by the retrieval document contents judgment section; and
a retrieval result output section, which outputs the document election result based on the judgment result by the retrieval document contents judgment section.

10. A document collection/retrieval system having a document database which preserves same document information indicating whether or not same document data having the same document contents exist and the weight information related to the same document data, such that the same document information is related to each document data, a document collection apparatus preserving the document data collected from a outside apparatus in the document database, and a documents retrieval apparatus retrieving the document data satisfying the retrieval condition as inputted from the database, wherein
a preservation document affirmation section, which affirms whether or not document data corresponding to collection target document data is preserved in the document database;
a same document existence affirmation section, which affirms whether or not same document data of the document data corresponding to the document collection target document data exists in the document database based on the same document information of the document data corresponding to the collection target document data, when the document data corresponding to the collection target document data is preserved in the document database.
a document extraction section, which extracts the collection target document data and the same document data of the document data corresponding to the collection target document data from the outside apparatus, when the same document data of the document data corresponding to the collection target document data exists in the document database;
a document contents judgment section, which judges whether or not document contents of the extracted collection target document data and document contents of the extracted same document data of the document data corresponding to the collection target documents data are same; and
a document information update section, which updates the same document information relating to the extracted collection target document data and the extracted same document data of the document data corresponding to the collection target document based on the judgment result of the document contents judgment section, and
the document retrieval apparatus comprising:
a document retrieval section, which retrieves the documents data satisfying the retrieval condition from the document database;
a retrieval document contents judgment section, which judges whether document contents of the document data retrieved by the document retrieval section are same or not;
a retrieval document information update section, which updates the same document information and the weight information related to the document data based on the judgment result by the retrieval document contents judgment section; and
a retrieval result output section, which outputs the document data retrieved by the document retrieval section, along with the weight information of the document data retrieved by the document retrieval section.
